(19) United States
(12) Patent Application Publication
(10) Pub. No.: US 2021/0025354 A1
(43) Pub. Date: Jan. 28, 2021

(54) Evaporated Fuel Processing Device

(71) Applicant: AISAN KOGYO KABUSHIKI KAISHA, Obu-shi (JP)

(72) Inventor: Kazuho MURATA, Nagoya-shi (JP)

(73) Assignee: AISAN KOGYO KABUSHIKI KAISHA, Obu-shi (JP)

(21) Appl. No.: 16/929,278

(22) Filed: Jul. 15, 2020

(30) Foreign Application Priority Data
Jul. 23, 2019 (JP) 2019-135225

(51) Int. Cl. F02M 25/08; B01D 53/04

(52) U.S. Cl. CPC F02M 25/0854; B01D 2253/102; B01D 2259/4516; B01D 53/0446

(57) ABSTRACT

An evaporated fuel processing device includes a casing having a passage through which gasses flow. The casing includes a pair of adsorbing chambers arranged in series relative to a flow direction of the gasses in the passage. The casing also includes a diffusion chamber positioned between the pair of adsorbing chambers. A first diffusing element and a second diffusing element are disposed in the diffusion chamber. The first diffusing element is a frustum-shaped member having a large-diameter opening portion opening into one of the pair adsorbing chambers and a small-diameter opening portion opening into the diffusion chamber. The second diffusing element is a frustum-shaped member having a large-diameter opening portion opening into the other of the pair of adsorbing chambers and a small-diameter opening portion opening into the diffusion chamber.

### CROSS-REFERENCE TO RELATED APPLICATIONS

This application claims benefit of Japanese Patent Application Serial No. 2019-135225 filed Jul. 23, 2019, which is hereby incorporated herein by reference in its entirety.

### BACKGROUND

The present disclosure relates generally to evaporated fuel processing devices. More particularly, the present disclosure relates to evaporated fuel processing devices configured to adsorb and desorb evaporated fuel generated in fuel tanks of automobiles or other such vehicles.

A known evaporated fuel processing device (canister) is taught by, for example, JP 2005-195007 A. The known evaporated fuel processing device includes a casing having a flow passage through which gasses flow. The casing has a tank port (gas inlet port) and a purge port that are in fluid communication with one end of the flow passage and an atmosphere port (vent port) that is in fluid communication with the opposite end of the flow passage. The casing has two adsorbing chambers therein, which are arranged in series relative to the flow directions of the gasses. The adsorbing chambers are filled with adsorbing materials capable of adsorbing evaporated fuel. The flow passage also has a diffusion chamber positioned between the two adsorbing chamber. The diffusion chamber is not filled with adsorbing materials, but instead contains a diffuser positioned adjacent to the adsorbing chambers. The diffuser is a plate-shaped member having a plurality of holes.

During a charging operation (adsorbing operation), e.g., during refueling, the gasses (evaporated fuel-containing gasses) flows into the flow passage of the casing via the tank port and then flows toward the atmosphere port. In contrast, during a purging operation (desorbing operation) for purging the evaporated fuel within the casing (flow passage), the gasses (atmospheric air or purge air) flows into the flow passage via the atmosphere port and then flows toward the purge port.

### SUMMARY

According to one aspect of the present disclosure, an evaporated fuel processing device may include a casing having a passage through which gasses flow. The casing includes a tank port and a purge port in fluid communication with one end portion of the passage, an atmosphere port in fluid communication with the opposite end portion of the passage, a first adsorbing chamber filled with adsorbing material for adsorbing evaporated fuel, a second adsorbing chamber filled with adsorbing material for adsorbing evaporated fuel, and a diffusion chamber positioned between the first adsorbing chamber and the second adsorbing chamber. The first adsorbing chamber and the second adsorbing chamber are arranged in series relative to the flow directions of the gasses in the passage. The diffusion chamber does not contain any adsorbing materials. A first diffusing element and a second diffusing element are disposed in the diffusion chamber. The first diffusing element comprises a frustum-shaped member having a large-diameter opening portion opening into the first adsorbing chamber and a small-diameter opening portion opening into the diffusion chamber. The second diffusing element comprises a frustum-shaped member having a large-diameter opening portion opening into the second adsorbing chambers and a small-diameter opening portion opens into the diffusion chamber.

According to one aspect of the disclosure, for example, the gasses introduced into one of the two adsorbing chambers are introduced into the first diffusing element positioned upstream in the diffusion chamber. The gasses introduced into the first diffusing element are converged while flowing therethrough and then introduced into a flow space of the diffusion chamber. The gasses passing through the flow space of the diffusion chamber are then be introduced into the second diffusing element positioned downstream in the diffusion chamber. The gasses introduced into the second diffusing element are diffused while flowing therethrough and then be introduced into another of the two adsorbing chambers. Thus, the gasses may be effectively homogenized in temperature thereof and concentration of evaporated fuel contained therein due to a labyrinth effect of the first and second diffusing elements. In particular, during a charging operation, evaporated fuel-containing gasses (the gasses) introduced into one of the two adsorbing chambers may be effectively homogenized in temperature thereof and concentration of evaporated fuel contained therein before the evaporated fuel-containing gasses are introduced into another of the two adsorbing chambers. Therefore, in another of the two adsorbing chambers, the evaporated fuel in the evaporated fuel-containing gasses may be effectively adsorbed. That is, adsorption efficiency of the evaporated fuel may be increased in the other of the two adsorbing chambers. As a result, the evaporated fuel may be substantially restricted and/or prevented from being released into the atmosphere via the atmosphere port. Conversely, during a purging operation, purge gasses (the gasses) may be effectively homogenized in temperature thereof and concentration of evaporated fuel contained therein before the purge gasses are introduced into one of the two adsorbing chambers. Therefore, in one of the two adsorbing chambers, the evaporated fuel in the adsorbing materials may be effectively desorbed. That is, desorption efficiency of the evaporated fuel may be increased in one of the two adsorbing chambers. As a result, the evaporated fuel in the adsorbing materials of one of the two adsorbing chambers may be effectively transferred to the purge air.

Other objects, features, and advantages, of the present disclosure will be readily understood after reading the following detailed description together with the accompanying drawings and the claims.

### BRIEF DESCRIPTION OF THE DRAWINGS

FIG. 1 is a cross-sectional side view of an evaporated fuel processing device according to a first embodiment;

FIG. 2 is a perspective view of the diffuser of the evaporated fuel processing device of FIG. 1;

FIG. 3 is a cross-sectional side view of the diffuser of FIG. 2;

FIG. 4 is a plan view of the diffuser of FIG. 2;

FIG. 5 is a cross-sectional side view of a diffuser contained in an evaporated fuel processing device according to a second embodiment;

FIG. 6 is a cross-sectional side view of a diffuser contained in an evaporated fuel processing device according to a third embodiment; and

FIG. 7 is a cross-sectional side view of a diffuser contained in an evaporated fuel processing device according to a fourth embodiment.

### DETAILED DESCRIPTION

As previously described, during a charging operation (adsorbing operation), the gasses (evaporated fuel-containing gasses) flow into the flow passage of the casing via the tank port and then flows toward the atmosphere port, and during a purging operation (desorbing operation), the gasses (atmospheric air or purge air) flows into the flow passage via the atmosphere port and then flows toward the purge port. According to the evaporated fuel processing device taught by JP 2005-195007 A, in both the charging operation and the purging operation, the gasses tend to flow through a central portion of the adsorbing chamber positioned upstream of the diffusers. That is, the gasses are less likely to flow through an outer peripheral portion of the adsorbing chamber. Further, because the diffuser is formed as the plate-shaped member with a plurality of holes, the gasses may be stagnated upstream of the diffuser such that the gasses may be restricted and/or prevented from being effectively dispersed downward. Consequently, the gasses may not be sufficiently homogenized with respect to temperature or concentration of evaporated fuel.

Due to the foregoing, during the charging operation, the gasses (the evaporated fuel-containing gasses) flowing through the adsorbing chamber positioned adjacent to the purge port (i.e., upstream of the diffuser) tend to flow through the central portion of the adsorbing chamber. As a result, the evaporated fuel containing gasses flowing through the central portion of the adsorbing chamber may be heated to a temperature greater than the outer peripheral portion of the adsorbing chamber due to condensation heat generated when the evaporated fuel is adsorbed by the adsorbing materials. Therefore, in the adsorbing chamber positioned downstream of the diffuser (i.e., positioned adjacent to the atmosphere port), adsorption efficiency of the evaporated fuel may be reduced. During the purging operation, the gasses (the purge air) flowing through the adsorbing chamber positioned adjacent to the atmosphere port (positioned upstream of the diffuser) tends to flow through the central portion of the adsorbing chamber. As a result, the purge air flowing through the central portion of the adsorbing chamber may be cooled to a temperature lower than the outer peripheral portion of the adsorbing chamber due to vaporization heat generated when the evaporated fuel is desorbed from the adsorbing materials. Therefore, in the adsorbing chamber positioned downstream of the diffuser (i.e., positioned adjacent to the purge port), desorption efficiency of the evaporated fuel may be reduced. Thus, there is a need in the art for an improved evaporated fuel processing device.

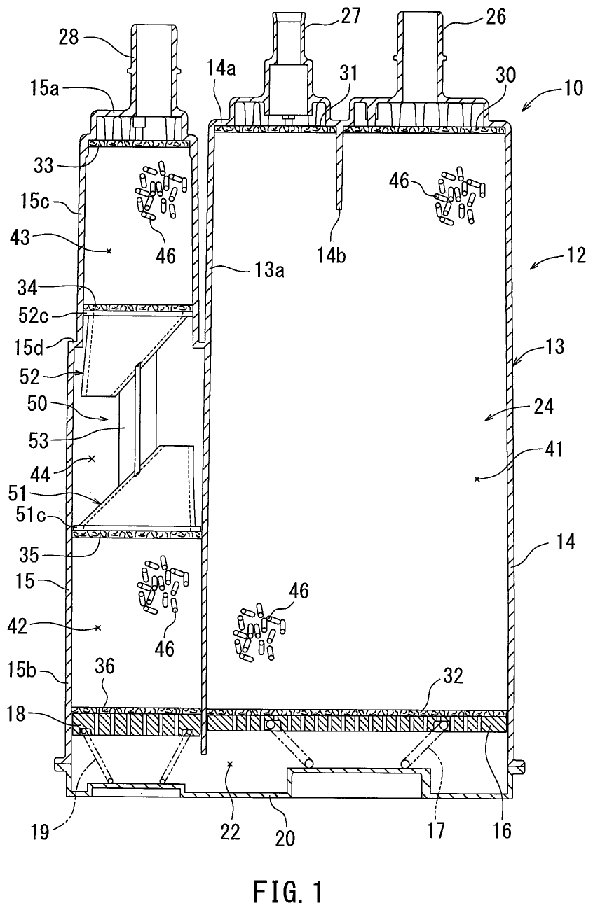

Detailed representative embodiments of the present disclosure for improving adsorption and desorption efficiencies are shown in FIG. 1 to FIG. 8.

A first detailed representative embodiment of the present disclosure will be described with reference to FIGS. 1 to 4. As shown in FIG. 1, this embodiment is directed to an evaporated fuel processing device 10. Further, in this embodiment, a canister for an automobile or other such vehicles is exemplified as the evaporated fuel processing device 10.

As shown in FIG. 1, the evaporated fuel processing device 10 includes a substantially rectangular box-shaped resin casing 12 and a diffuser or diffusion device 50 disposed in the casing 12. The casing 12 comprises a generally rectangular casing body 13 having an open lower end and a dish-shaped closing member 20 closing the open lower end of the casing body 13. The casing body 13 includes a rectangular cylindrical portion 14 having an upper end wall 14a and a shouldered circular cylindrical portion 15 having an upper end wall 15a.

As shown in FIG. 1, the rectangular cylindrical portion 14 and the cylindrical portion 15 are positioned laterally adjacent (juxtaposed) to each other. As shown in FIG. 1, the cylindrical portion 15 is positioned on the left of the rectangular cylindrical portion 14. An interior space of the rectangular cylindrical portion 14 and an interior space of the cylindrical portion 15 are in fluid communication with each other via a communicating chamber 22 formed between the casing body 13 and the closing member 20. Thus, a substantially U-shaped passage 24 defined by the interior space of the rectangular cylindrical portion 14, the communicating chamber 22, and the interior space of the cylindrical portion 15 is provided in the casing 12. The passage 24 functions as a flow passage through which gasses can flow.

The cylindrical portion 15 includes a lower, relatively large-diameter cylindrical portion 15b and an upper, relatively small-diameter cylindrical portion 15c connected to the lower cylindrical portion 15b at an annular shoulder 15d. The lower cylindrical portion 15b, the upper cylindrical portion 15c, and the annular shoulder 15d are axially (vertically) arranged and coaxially aligned. The cylindrical portion 15 may be partially integrated with the rectangular cylindrical portion 14. For example, in this embodiment, the lower cylindrical portion 15b of the cylindrical portion 15 is integrated with a wall 13a of the rectangular cylindrical portion 14. That is, the rectangular cylindrical portion 14 is configured such that the wall 13a thereof functions as a common dividing wall between the lower cylindrical portion 15b of the cylindrical portion 15 and the rectangular cylindrical portion 14. Conversely, the upper cylindrical portion 15c may be separated from the wall 13a of the rectangular cylindrical portion 14.

As shown in FIG. 1, the rectangular cylindrical portion 14 includes a tank port 26 and a purge port 27 that are in fluid communication with the interior space of the rectangular cylindrical portion 14. The tank port 26 and the purge port 27 are formed in the upper end wall 14a of the rectangular cylindrical portion 14. In this embodiment, the tank port 26 and the purge port 27 are stepped cylindrical projections extending upward from the upper end wall 14a. The tank port 26 is in fluid communication with a gaseous space of a fuel tank (not shown) whereas the purge port 27 is in fluid communication with an intake duct of a vehicle engine. The cylindrical portion 15 includes an atmosphere port 28 is in fluid communication with the interior space of the cylindrical portion 15. The atmosphere port 28 is formed in the upper end wall 15a of the cylindrical portion 15. In this embodiment, the atmosphere port 28 is a stepped cylindrical projection extending upward from the upper end wall 15a. The atmosphere port 28 is open to the atmosphere.

As shown in FIG. 1, the rectangular cylindrical portion 14 includes a partition wall 14b projecting downward from the upper end wall 14a thereof. The partition wall 14b divides an upper portion of the interior space of the rectangular cylindrical portion 14 into two portions—a first portion facing the tank port 26 and a second portion facing the purge port 27. The rectangular cylindrical portion 14 includes a (first) sheet-shaped filter 30 disposed in the first portion facing the tank port 26 and covering the tank port 26 from below. Further, the rectangular cylindrical portion 14 includes a (second) sheet-shaped filter 31 disposed in the second portion facing the purge port 27 and covering the purge port 27 from below.

As shown in FIG. 1, the rectangular cylindrical portion 14 includes a gas permeable porous plate 16 made of resin or other such materials. The porous plate 16 is disposed in a lower opening portion of the rectangular cylindrical portion 14. The porous plate 16 includes a (third) sheet-shaped filter 32 laid thereon. The filter 32 covers the porous plate 16 from above. Further, a biasing member 17, e.g., a coil spring, is disposed between the porous plate 16 and the closing member 20. The biasing member 17 biases the porous plate 16 upward. Thus, a first adsorbing chamber 41 defined by the filters 30, 31 and the filter 32 is formed within the rectangular cylindrical portion 14.

As shown in FIG. 1, the cylindrical portion 15 includes a (fourth) sheet-shaped filter 33 disposed in an upper portion of the interior space thereof and covering the atmosphere port 28 from below. Further, the diffusion device 50 is disposed in a central portion of the interior space of the cylindrical portion 15. Further, the cylindrical portion 15 includes a (fifth) sheet-shaped filter 34 and a (sixth) sheet-shaped filter 35 disposed in the interior space thereof. The filter 34 is positioned on an upper side of the diffusion device 50 and covers an upper surface of the diffusion device 50 from above. Conversely, the filter 35 is positioned on a lower side of the diffusion device 50 and covers a lower surface of the diffusion device 50 from below. Thus, an adsorbing chamber 43 defined by the filter 33 and the filter 34 is formed within the upper cylindrical portion 15c of the cylindrical portion 15. The adsorbing chamber 43 may also be referred to herein as a third adsorbing chamber 43. Further, a (circular) cylindrical chamber 44 defined by the filter 34 and the filter 35 is formed within the central portion of the interior space of the cylindrical portion 15. The chamber 44 may also be hereinafter referred to herein as a diffusion chamber 44.

The cylindrical portion 15 also includes a gas permeable porous plate 18 made of resin or other such materials. The porous plate 18 is disposed in a lower opening portion of the cylindrical portion 15. The porous plate 18 has a (seventh) sheet-shaped filter 36 laid thereon. The filter 36 covers the porous plate 18 from above. Further, a biasing member 19, e.g., a coil spring, is disposed between the porous plate 18 and the closing member 20. The biasing member 19 biases the porous plate 18 upward. Thus, an adsorbing chamber 42 defined by the filter 35 and the filter 36 is formed within the lower cylindrical portion 15b of the cylindrical portion 15. The adsorbing chamber 42 may also be referred to herein as a second adsorbing chamber 42.

Thus, the casing 12 includes the first to third adsorbing chambers 41, 42,43 arranged in series along the passage 24 (i.e., in series relative to the flow directions of the gasses) and in fluid communication with each other. The filters 30-36 are preferably be made of resin non-woven fabric, urethane foam or other such materials. In particular, in this embodiment, the filters 34, 35 are made of urethane foam.

The first to third adsorbing chambers 41, 42, 43 are respectively filled with adsorbent or adsorbing materials 46 configured to adsorb and desorb evaporated fuel. Examples of the adsorbing materials 46 include granular activated carbon, which may be pulverized activated carbon, granulated activated carbon (products formed by granulating a mixture of powdered activated carbon and binding materials), or other such shaped activated carbon. Conversely, the communicating chamber 22 and the diffusion chamber 44 are not filled with any adsorbing materials.

As shown in FIG. 1, the diffusion device 50 is disposed in the diffusion chamber 44. The diffusion device 50 is composed of a first diffusing element 51, a second diffusing element 52, and a connecting member 53 coupling the first and second diffusing elements 51, 52. The first diffusing element 51 is positioned on a lower portion of the diffusion chamber 44, i.e., positioned adjacent to the second adsorbing chamber 42. Conversely, the second diffusing element 52 is positioned on an upper portion of the diffusion chamber 44, i.e., positioned adjacent to the third adsorbing chamber 43. The diffusion device 50 is preferably be made of resin as a unit.

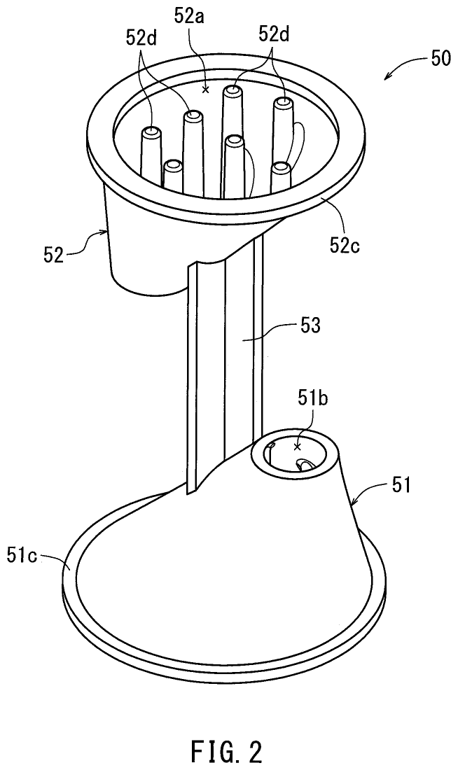

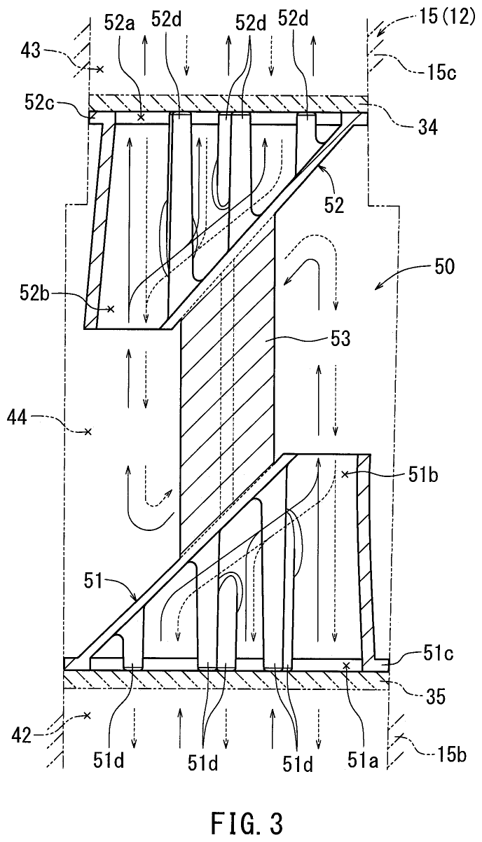

As shown in FIGS. 2 and 3, the first diffusing element 51 is formed as an asymmetrical open-ended frustum-shaped (frust-conical or truncated cone-shaped) member that gradually decreases in diameter moving upward from its lower end while its axis is radially tilted (rightward as shown in FIG. 3). In particular, the first diffusing element 51 has a lower large-diameter (circular) opening portion 51a and an upper small-diameter (circular) opening portion 51b that are eccentrically positioned with each other. That is, the first diffusing element 51 is configured such that the upper small-diameter opening portion 51b is radially deflected and offset (rightward in FIG. 3) relative to the lower large-diameter opening portion 51a (FIG. 3). Further, the first diffusing element 51 is configured such that a lower surface thereof (an end surface of the lower large-diameter opening portion 51a) and an upper surface thereof (an end surface of the upper small-diameter opening portion 51b) are oriented parallel to each other. In this embodiment, the first diffusing element 51 has an annular flange 51c extending along the outer circumference of a lower end thereof (i.e., an end corresponding to the lower large-diameter opening portion 51a). The annular flange 51c is closely fit in a lower end of the diffusion chamber 44 (an end adjacent to the second adsorbing chamber 42), i.e., in the lower cylindrical portion 15b of the cylindrical portion 15 of the casing 12. Thus, the first diffusing element 51 is positioned on the lower portion of the diffusion chamber 44 while the lower large-diameter opening portion 51a opens into the second adsorbing chamber 42, whereas the upper small-diameter opening portion 51b opens into the diffusion chamber 44.

As shown in FIGS. 2 and 3, the second diffusing element 52 is formed as an asymmetrical open-ended frustum-shaped (frust-conical or truncated cone-shaped) member that gradually decreases in diameter moving downward from its upper end while its axis is radially tilted in a direction opposite to the axis of the first diffusing element 51 (leftward as shown in FIG. 3). In particular, the second diffusing element 52 has an upper large-diameter (circular) opening portion 52a and a lower small-diameter (circular) opening portion 52b that are eccentrically positioned with each other. That is, the second diffusing element 52 is configured such that the lower small-diameter opening portion 52b is radially deflected and offset (leftward in FIG. 3) relative to the upper large-diameter opening portion 52a (FIG. 3). Further, the second diffusing element 52 is configured such that an upper surface thereof (an end surface of the upper large-diameter opening portion 52a) and a lower surface thereof (an end surface of the lower small-diameter opening portion 52b) are oriented parallel to each other. In this embodiment, the second diffusing element 52 has an annular flange 52c extending along the outer circumference of an upper end thereof (i.e., an end corresponding to the upper large-diameter opening portion 52a). The annular flange 52c is closely fit in an upper end of the diffusion chamber 44 (an end adjacent to the third adsorbing chamber 43), i.e., in the upper cylindrical portion 15c of the cylindrical portion 15 of the casing 12. Thus, the second diffusing element 52 is positioned on the upper portion of the diffusion chamber 44 while the upper large-diameter opening portion 52a opens into the third adsorbing chamber 43, whereas the lower small-diameter opening portion 52b opens into the diffusion chamber 44.

The first diffusing element 51 and the second diffusing element 52 of the diffusion device 50 are constructed and positioned as described above. Therefore, as shown in FIG. 3, the lower large-diameter opening portion 51a of the first diffusing element 51 and the upper large-diameter opening portion 52a of the second diffusing element 52 are aligned with each other in an axial direction of the diffusion chamber 44. In other words, the lower large-diameter opening portion 51a and the upper large-diameter opening portion 52a are vertically concentrically positioned. Further, in this embodiment, the upper small-diameter opening portion 51b of the first diffusing element 51 has the same (inner) diameter as the lower small-diameter opening portion 52b of the second diffusing element 52.

As shown in FIG. 3, the first diffusing element 51 includes a plurality of (seven in this embodiment) columnar pin-shaped support members 51d that are separately formed on an inner surface thereof. The support members 51d project vertically downward from the inner surface of the first diffusing element 51. The support members 51d are configured such that the lower end surfaces thereof are flush with the lower surface of the first diffusing element 51 (the end surface of the lower large-diameter opening portion 51a). The support members 51d function to prevent the filter 35 covering the lower large-diameter opening portion 51a of the first diffusing element 51 from entering the first diffusing element 51.

As shown in FIGS. 2 to 4, the second diffusing element 52 includes a plurality of (seven in this embodiment) columnar pin-shaped support members 52d that are separately formed on an inner surface thereof. The support members 52d project vertically upward from the inner surface of the second diffusing element 52. The support members 52d are configured such that upper end surfaces thereof are flush with the upper surface of the second diffusing element 52 (the end surface of the upper large-diameter opening portion 52a). Further, the support members 52d function to prevent the filter 34 covering the upper large-diameter opening portion 52a of the second diffusing element 52 from entering the second diffusing element 52.

As shown in FIGS. 1 to 3, the connecting member 53 is a vertically oriented, elongate pillar-shaped member having a cross shaped cross-section. The connecting member 53 is positioned between an outer surface of the first diffusing element 51 and an outer surface of the second diffusing element 52 and connected thereto. Thus, the first diffusing element 51 and the second diffusing element 52 may be integrated with each other. Further, as shown in FIG. 3, the connecting member 53 may is preferably positioned so as to be axially aligned with the lower large-diameter opening portion 51a of the first diffusing element 51 and the upper large-diameter opening portion 52a of the second diffusing element 52.

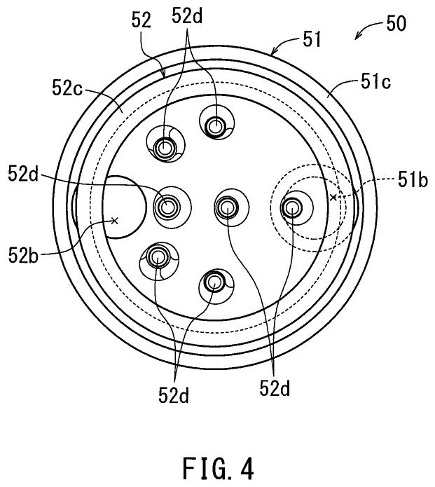

As shown in FIG. 3, the first diffusing element 51 and the second diffusing element 52 are positioned in the diffusion chamber 44 such that the upper small-diameter opening portion 51b of the first diffusing element 51 and the lower small-diameter opening portion 52b of the second diffusing element 52 are transversely and laterally displaced relative to each other. In particular, the first diffusing element 51 and the second diffusing element 52 are positioned such that the upper small-diameter opening portion 51b and the lower small-diameter opening portion 52b are respectively positioned on transversely and laterally opposite sides of the connecting member 53. That is, the first diffusing element 51 and the second diffusing element 52 are positioned such that the upper small-diameter opening portion 51b and the lower small-diameter opening portion 52b do not overlap each other and are not aligned with each other as viewed in the axial (vertical) direction of the diffusion chamber 44 (FIG. 4). Further, the first diffusing element 51 and the second diffusing element 52 are configured such that a (reduced diameter) part including the upper small-diameter opening portion 51b and a (reduced diameter) part including the lower small-diameter opening portion 52b do not (vertically) overlap each other along an axis of the diffusion chamber 44. That is, the first diffusing element 51 and the second diffusing element 52 are configured such that the upper small-diameter opening portion 51b of the first diffusing element 51 is positioned below the lower small-diameter opening portion 52b of the second diffusing element 52 in the diffusion chamber 44.

A charging operation of the evaporated fuel processing device 10 will now be described. For example, in a condition in which the vehicle engine (not shown) is stopped, evaporated fuel-containing gasses (evaporated fuel-containing air) generated in the fuel tank may be introduced into the first adsorbing chamber 41 through the tank port 26, so that the evaporated fuel contained in the evaporated fuel-containing gasses may be adsorbed by the adsorbing materials 46 in the first adsorbing chamber 41. The evaporated fuel-containing gasses passing through the first adsorbing chamber 41 is then introduced into the second adsorbing chamber 42 via the communicating chamber 22, such that the evaporated fuel contained therein (i.e., the evaporated fuel remaining in the evaporated fuel-containing gasses without being adsorbed by the adsorbing materials 46 in the first adsorbing chamber 41) may be adsorbed by the adsorbing materials 46 in the second adsorbing chamber 42.

The evaporated fuel-containing gasses passing through the second adsorbing chamber 42 are then be introduced into the first diffusing element 51 of the diffusion device 50 positioned in the diffusion chamber 44. The evaporated fuel-containing gasses introduced into the first diffusing element 51 converge while flowing therethrough and are then introduced into a flow space of the diffusion chamber 44. The evaporated fuel-containing gasses passing through the flow space of the diffusion chamber 44 are then be introduced into the second diffusing element 52 of the diffusion device 50. The evaporated fuel-containing gasses introduced into the second diffusing element 52 are be diffused while flowing therethrough and then be introduced into the third adsorbing chamber 43, such that the evaporated fuel contained therein (i.e., the evaporated fuel remaining in the evaporated fuel-containing gasses without being adsorbed by the adsorbing materials 46 in the second adsorbing chamber 42) may be adsorbed by the adsorbing materials 46 in the third adsorbing chamber 43. A flow path of the evaporated fuel-containing gasses in the diffusion chamber 44 is shown by solid arrowed lines in FIG. 3. As a result, pure gasses (air) containing little to none of the evaporated fuel is produced in the third adsorbing chamber 43. The pure gasses thus produced are released into the atmosphere via the atmosphere port 28. Further, during the charging operation, the tank port 26 is positioned upstream of the diffusion chamber 44 while the atmosphere port 28 may be positioned downstream of the diffusion chamber 44.

Next, a purging operation of the evaporated fuel processing device 10 will be described. When conditions for purging are satisfied in a condition in which the vehicle engine is operated, a manifold negative pressure of the engine is applied to the passage 24 formed in the casing 12 via the purge port 27. As a result, atmospheric air or purge air (gasses) are introduced into the third adsorbing chamber 43 via the atmosphere port 28. The purge air introduced into the third adsorbing chamber 43 flows therethrough while desorbing the evaporated fuel adsorbed to the adsorbing materials 46 in the third adsorbing chamber 43, and then flows into the second diffusing element 52 of the diffusion device 50. The purge air introduced into the second diffusing element 52 converges while flowing therethrough and is then introduced into the flow space of the diffusion chamber 44. The purge air passing through the flow space of the diffusion chamber 44 is then introduced into the first diffusing element 51 of the diffusion device 50. The purge air introduced into the first diffusing element 51 is diffused while flowing therethrough and then introduced into the second adsorbing chamber 42. The purge air introduced into the second adsorbing chamber 42 flows therethrough while desorbing the evaporated fuel adsorbed to the adsorbing materials 46 in the second adsorbing chamber 42. A flow path of the purge air in the diffusion chamber 44 is shown by broken arrowed lines in FIG. 3.

The purge air passing through the second adsorbing chamber 42 is then be introduced into the first adsorbing chamber 41 via the communicating chamber 22. The purge air introduced into the first adsorbing chamber 41 flows therethrough while desorbing the evaporated fuel adsorbed to the adsorbing materials 46 in the first adsorbing chamber 41. Thereafter, the purge air containing the evaporated fuel thus produced is sent to the engine via the purge port 27 for combustion. Further, during the purging operation, the atmosphere port 28 is positioned upstream while the purge port 27 is positioned downstream of the diffusion chamber 44.

The diffusion device 50 is configured such that an opening area of the upper small-diameter opening portion 51b of the first diffusing element 51 and an opening area of the lower small-diameter opening portion 52b of the second diffusing element 52 are each greater than a minimum cross-sectional area of the passage 24 formed in the casing 12 (i.e., a minimum sectional area of the passage 24 in a direction perpendicular to the flow directions of the gasses). In particular, the first diffusing element 51 and the second diffusing element 52 are configured such that the opening areas of the upper small-diameter opening portion 51b and the lower small-diameter opening portion 52b are each greater than a minimum value of a cross-sectional area of the tank port 26, a cross-sectional area of the purge port 27, a cross-sectional area of the atmosphere port 28, and a total cross-sectional area of the pores formed in each of the porous plates 16 and 18. The second adsorbing chamber 42 and the third adsorbing chamber 43 may also be referred to herein as a purge port-side adsorbing chamber and an atmosphere port-side adsorbing chamber, respectively.

According to the evaporated fuel processing device 10, during the charging operation, the evaporated fuel-containing gasses passing through the second adsorbing chamber 42 is introduced into the first diffusing element 51 of the diffusion device 50 positioned in the diffusion chamber 44. The evaporated fuel-containing gasses introduced into the first diffusing element 51 converge while flowing therethrough. Thereafter, the evaporated fuel-containing gasses are introduced into the second diffusing element 52 of the diffusion device 50 via the flow space of the diffusion chamber 44. The evaporated fuel-containing gasses introduced into the second diffusing element 52 are diffused while flowing therethrough and then introduced into the third adsorbing chamber 43. Thus, the evaporated fuel-containing gasses passing through the second adsorbing chamber 42 are introduced into the diffusion chamber 44 and then be introduced into the third adsorbing chamber 43. That is, the evaporated fuel-containing gasses are effectively homogenized in temperature thereof and concentration of evaporated fuel contained therein due to a labyrinth effect of the first and second diffusing elements 51, 52 before the evaporated fuel-containing gasses are introduced into the third adsorbing chamber 43. Therefore, in the third adsorbing chamber 43, the evaporated fuel in the evaporated fuel-containing gasses are effectively adsorbed by the adsorbing materials 46 in the third adsorbing chamber 43. That is, adsorption efficiency of the evaporated fuel in the third adsorbing chamber 43 may be increased. As a result, the evaporated fuel may be substantially prevented from being released into the atmosphere via the atmosphere port 28.

Conversely, during the purging operation, the purge gasses passing through the third adsorbing chamber 43 are introduced into the second diffusing element 52 of the diffusion device 50 positioned in the diffusion chamber 44. The purge gasses introduced into the second diffusing element 52 converge while flowing therethrough. Thereafter, the purge gasses are introduced into the first diffusing element 51 of the diffusion device 50 via the flow space of the diffusion chamber 44. The purge gasses introduced into the first diffusing element 51 are diffused while flowing therethrough and then introduced into the second adsorbing chamber 42. Thus, the purge gasses passing through the third adsorbing chamber 43 are introduced into the diffusion chamber 44 and then introduced into the second adsorbing chamber 42. That is, the purge gasses are effectively homogenized in temperature thereof and concentration of evaporated fuel contained therein due to the labyrinth effect of the first and second diffusing elements 51, 52 before the purge gasses are introduced into the second adsorbing chamber 42. Therefore, in the second adsorbing chamber 42, the evaporated fuel adsorbed to the adsorbing materials 46 are effectively desorbed. That is, desorption efficiency of the evaporated fuel in the second adsorbing chamber 42 may be increased. As a result, the evaporated fuel may be effectively sent to the engine via the purge port 27.

The first diffusing element 51 is closely fit in the lower end of the diffusion chamber 44 at an end corresponding to the lower large-diameter opening portion 51a. Further, the second diffusing element 52 is closely fit in the upper end of the diffusion chamber 44 at an end corresponding to the upper large-diameter opening portion 52a. Therefore, the evaporated fuel-containing gasses passing through the second adsorbing chamber 42 are fully introduced into the first diffusing element 51. Also, the purge gasses passing through the third adsorbing chamber 43 are fully introduced into the second diffusing element 52.

Further, the upper small-diameter opening portion 51b of the first diffusing element 51 and the lower small-diameter opening portion 52b of the second diffusing element 52 are positioned so as to not radially overlap each other as viewed in the axial direction of the diffusion chamber 44. Therefore, the flow path of the gasses (the purge gasses and the evaporated fuel-containing gasses) are lengthened between the upper small-diameter opening portion 51b of the first diffusing element 51 and the lower small-diameter opening portion 52b of the second diffusing element 52. As a result, a diffusion rate of the evaporated fuel may be effectively delayed. Further, the evaporated fuel may be restricted from being released via the atmosphere port 28 during the charging operation.

Further, the opening area of the upper small-diameter opening portion 51b of the first diffusing element 51 and the opening area of the lower small-diameter opening portion 52b of the second diffusing element 52 are each greater than the minimum cross-sectional area of the passage 24 formed in the casing 12. Therefore, the gasses (the purge gasses and the evaporated fuel-containing gasses) may flow smoothly through the passage 24 without being inhibited by the upper small-diameter opening portion 51b of the first diffusing element 51 and the lower small-diameter opening portion 52b of the second diffusing element 52.

Further, the first diffusing element 51 and the second diffusing element 52 may be integrated with each other by the connecting member 53. Therefore, the first diffusing element 51 and the second diffusing element 52 may be easily and accurately disposed within and coupled to the casing 12.

Further, the first diffusing element 51 may have the support members 51d that are configured to support the filter 35 covering the lower large-diameter opening portion 51a of the first diffusing element 51. Therefore, the filter 35 may be effectively supported by the support members 51d.

Further, the second diffusing element 52 may have the support members 52d that are configured to support the filter 34 covering the upper large-diameter opening portion 52a of the second diffusing element 52. Therefore, the filter 34 may be effectively supported by the support members 52d.

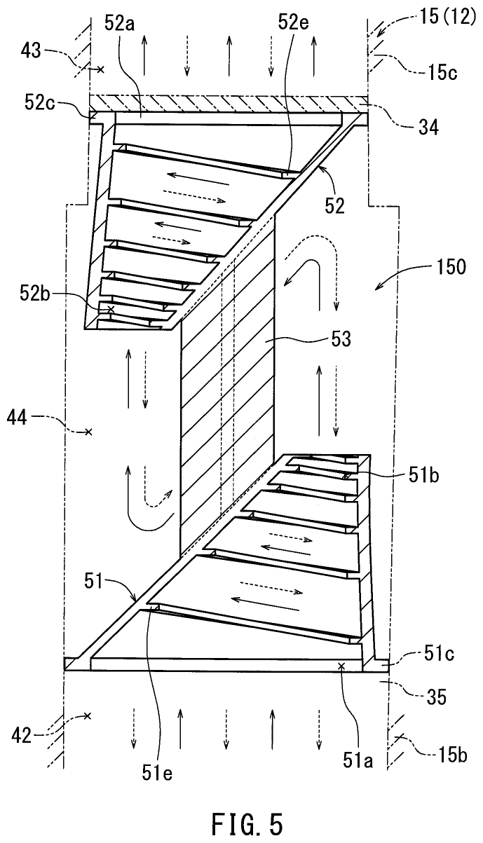

A second detailed representative embodiment of the present disclosure will now be described with reference to FIG. 5.

Because the second embodiment relates to the first embodiment, only the constructions and elements that are different from the first embodiment will be explained in detail. In particular, this embodiment is different from the first embodiment in that the diffusion device 50 is replaced with a diffusion device 150. Therefore, only the constructions and elements of the diffusion device 150 that are different from the diffusion device 50 will be hereinafter explained.

As shown in FIG. 5, similar to diffusion device 50, diffusion device 150 includes the first diffusing element 51 and the second diffusing element 52. The first diffusing element 51 comprises a helical projection or rib 51e that extends and spirals about in the inner surface thereof. Thus, a helical slope is formed in the inner surface of the first diffusing element 51. Similarly, the second diffusing element 52 comprises a helical projection or rib 52e that extends and spirals about the inner surface thereof. Thus, a helical slope is formed in the inner surface of the second diffusing element 52. Each helical rib 51e, 52e may also be referred to herein as a “swirl flow-generating portion.” In FIG. 5, the support members 51d, 52d of the first and second diffusing elements 51, 52, respectively, are omitted for clarification.

According to this embodiment, the gasses (the evaporated fuel-containing gasses or the purge gasses) introduced into the first diffusing element 51 flow while being helically guided by the helical ribs 51e. That is, the helical ribs 51e induce a swirl flow of the gasses introduced into the first diffusing element 51. As a result, the gasses are stirred so as to be further homogenized in temperature thereof and concentration of evaporated fuel contained therein. The flow path of the gasses (the evaporated fuel-containing gasses) during the charging operation are shown by solid arrowed lines in FIG. 5. Conversely, a flow path of the gasses (the purge gasses) during the purging operation are shown by broken arrowed lines in FIG. 5.

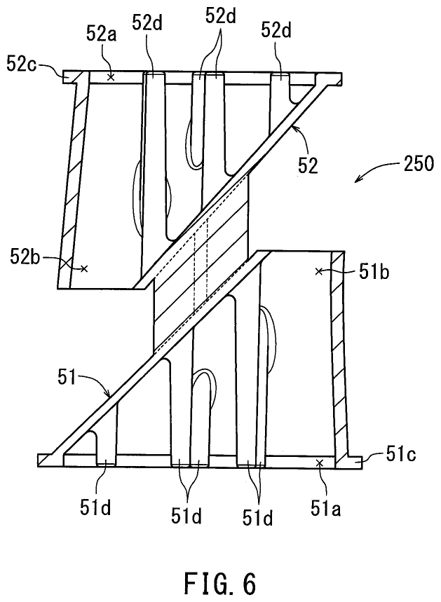

A third detailed representative embodiment of the present disclosure will be described with reference to FIG. 6.

Because the third embodiment relates to the first embodiment, only the constructions and elements that are different from the first embodiment will be explained in detail. In particular, this embodiment is different from the first embodiment in that the diffusion device 50 is replaced with a diffusion device 250. Therefore, only the constructions and elements of the diffusion device 250 that are different from the diffusion device 50 will be hereinafter explained.

As shown in FIG. 6, similar to the diffusion device 50, the diffusion device 250 includes the first diffusing element 51 and the second diffusing element 52. Unlike the first embodiment, the first diffusing element 51 and the second diffusing element 52 of diffusion device 50 are configured such that the part including the upper small-diameter opening portion 51b of the first diffusing element 51 and the part including the lower small-diameter opening portion 52b of the second diffusing element 52 (vertically) overlap each other along the axis of the diffusion chamber 44. That is, the connecting member 53 is configured such that the upper small-diameter opening portion 51b of the first diffusing element 51 is positioned above the lower small-diameter opening portion 52b of the second diffusing element 52 in the diffusion chamber 44.

According to the embodiment, the labyrinth effect of the first and second diffusing elements 51 and 52 may be further increased. Further, the diffusion device 250 may be reduced in length (vertical height).

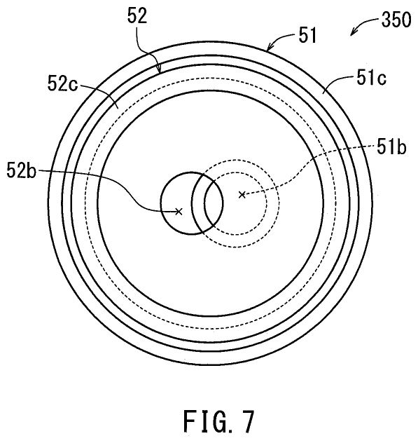

A fourth detailed representative embodiment of the present disclosure will be described with reference to FIG. 7.

Because the fourth embodiment relates to the first embodiment, only the constructions and elements that are different from the first embodiment will be explained in detail. In particular, this embodiment is different from the first embodiment in that the diffusion device 50 is replaced with a diffusion device 350. Therefore, only the constructions and elements of the diffusion device 350 that are different from the diffusion device 50 will be hereinafter explained.

As shown in FIG. 7, similar to the diffusion device 50, the diffusion device 350 includes the first diffusing element 51 and the second diffusing element 52. The first diffusing element 51 and the second diffusing element 52 are configured such that the upper small-diameter opening portion 51b of the first diffusing element 51 and the lower small-diameter opening portion 52b of the second diffusing element 52 partially radially overlap each other as viewed in the axial direction of the diffusion chamber 44. In FIG. 7, the support members 51d, 52d of the first and second diffusing elements 51 and 52, respectively, are omitted for simplification.

According to the embodiment, the upper small-diameter opening portion 51b of the first diffusing element 51 and the lower small-diameter opening portion 52b of the second diffusing element 52 do not entirely radially overlap each other as viewed in the axial direction of the diffusion chamber 44. Therefore, similar to the first embodiment, the flow path of the gasses is lengthened between the upper small-diameter opening portion 51b and the lower small-diameter opening portion 52b. As a result, the diffusion rate of the evaporated fuel may be effectively delayed. Further, the evaporated fuel may be restricted from being released via the atmosphere port 28 during the charging operation.

Naturally, various changes and modifications may be made to the embodiments of evaporated fuel processing devices disclosed herein. For example, embodiments of the evaporated fuel processing devices disclosed herein (e.g., evaporated fuel processing device 10) are intended to be applied to the vehicles. However, the evaporated fuel processing devices may be applied to ships or industrial machines. Further, embodiments of the evaporated fuel processing devices disclosed herein include the first to third adsorbing chambers 41, 42 and 43. However, in other embodiments, the evaporated fuel processing devices may have only two adsorbing chambers arranged in series in the flow directions of the gasses and configured such that the diffusion chamber is positioned therebetween. Therefore, the first and second adsorbing chambers 41 and 42 may be integrated to form a single adsorbing chamber.

Further, in the embodiments disclosed herein, the large-diameter opening portion 51a of the first diffusing elements 51 and the large-diameter opening portion 52a of the second diffusing elements 52 have a generally circular shapes. However, the large-diameter opening portion 51a and the large-diameter opening portion 52a may have other geometries such as elliptical shapes, polygonal shapes, or other shapes. Similarly, the small-diameter opening portion 51b of the first diffusing elements 51 and the small-diameter opening portion 52b of the second diffusing elements 52 may be changed in shape so as to have elliptical shapes, polygonal shapes, or other shapes. Also, the small-diameter opening portion 51b and the small-diameter opening portion 52b may be different from each other in shape, diameter, or other such particulars.

Further, in the embodiments, the helical ribs 51e and 52e are formed as the swirl flow-generating portions. However, the swirl flow-generating portions may have other forms such as fins, grooves, and independent ribs. Further, one of the helical ribs 51e, 52e may be omitted. Further, the columnar pin-shaped support members 51d, 52d may be changed in number, shape, or other such particulars. Further, the columnar pin-shaped support members 51d, 52d may be omitted as necessary. Further, the connecting member 53 may be changed in shape.

The passage 24 is not limited to U-shape. The passage 24 may have various shapes, e.g., I-shape. In addition, the tank port 26 and the purge port 27 may be formed as a single common port. Further, the diffusion chamber 44 may be changed in shape so as to have an elliptical cylindrical shape, a polygonal cylindrical shape, or other shape.

Representative examples of the present disclosure have been described in detail with reference to the attached drawings. This detailed description is merely intended to teach a person of skill in the art further details for practicing preferred aspects of the present disclosure and is not intended to limit the scope of the disclosure. Only the claims define the scope of the claimed disclosure. Therefore, combinations of features and steps disclosed in the foregoing detail description may not be necessary to practice the disclosure in the broadest sense, and are instead taught merely to particularly describe detailed representative examples of the disclosure. Moreover, the various features taught in this specification may be combined in ways that are not specifically enumerated in order to obtain additional useful embodiments of the present disclosure.

What is claimed is:

1. An evaporated fuel processing device, comprising:
a casing including a passage configured to flow gasses therethrough, a tank port in fluid communication with a first end of the passage, a purge port in fluid communication with the first end of the passage, an atmosphere port in fluid communication with a second end of the passage, a pair of adsorbing chambers filled with adsorbing materials configured to adsorb evaporated fuel and arranged in series relative to a flow direction of gasses through the passage, and a diffusion chamber positioned between the pair of adsorbing chambers, wherein the diffusion chamber is not filled with any adsorbing materials;
a first diffusing element and a second diffusing element disposed in the diffusion chamber, wherein the first diffusing element is a frustum-shaped member having a large-diameter opening portion opening into one of the pair of adsorbing chambers and a small-diameter opening portion opening into the diffusion chamber, and wherein the second diffusing element is a frustum-shaped member having a large-diameter opening portion opening into the other of the pair of adsorbing chambers and a small-diameter opening portion opening into the diffusion chamber.

2. The evaporated fuel processing device of claim 1, wherein an end of the first diffusing element corresponding to the lower large-diameter opening portion is closely fit in an end of the diffusion chamber adjacent to one of the pair of adsorbing chambers, and wherein an end of the second diffusing element corresponding to the lower large-diameter opening portion is closely fit in an end of the diffusion chamber adjacent to the other of the pair of adsorbing chambers.

3. The evaporated fuel processing device of claim 1, wherein at least one of the first diffusing element and the second diffusing element has a swirl flow-generating portion formed in an inner surface thereof and configured to helically guide the gasses flowing therethrough.

4. The evaporated fuel processing device of claim 1, wherein the small-diameter opening portion of the first diffusing element and the small-diameter opening portion of the second diffusing element are arranged so as to not radially overlap each other as viewed along an axis of the diffusion chamber.

5. The evaporated fuel processing device of claim 4, wherein the small-diameter opening portion of the first diffusing element and the small-diameter opening portion of the second diffusing element axially overlap each other relative to the axis of the diffusion chamber.

6. The evaporated fuel processing device of claim 1, wherein the small-diameter opening portion of the first diffusing element and the small-diameter opening portion of the second diffusing element partially radially overlap each other as viewed along an axis of the diffusion chamber.

7. The evaporated fuel processing device of claim 1, wherein an opening area of the small-diameter opening portion of the first diffusing element and an opening area of the small-diameter opening portion of the second diffusing element are each greater than a minimum cross-sectional area of the passage.

8. The evaporated fuel processing device of claim 1, wherein the first diffusing element and the second diffusing element are connected to each other by a connecting member.

9. The evaporated fuel processing device of claim 1, wherein at least one of the first diffusing element and the second diffusing element has support members configured to support a filter covering the large-diameter opening portion thereof.

10. An evaporated fuel processing device, comprising:
a casing having a passage configured to flow gasses therethrough;
a pair of adsorbing chambers in the casing and arranged in series along the passage relative to the flow of gasses through the passage;
a diffusion chamber formed in the casing and positioned between the pair of adsorbing chambers; and
a diffusion device disposed in the diffusion chamber, wherein the diffusion device includes a first diffusing element and a second diffusing element, wherein the first diffusing element is an asymmetrical frustum-shaped member having a large-diameter opening portion and a small-diameter opening portion, and wherein the second diffusing element is an asymmetrical frustum-shaped member having a large-diameter opening portion and a small-diameter opening portion;
wherein the first diffusing element is positioned with the large-diameter opening portion thereof opening into one of the pair of adsorbing chambers and the second diffusing element is positioned with the large-diameter opening portion thereof opening into the other of the pair of adsorbing chambers.

11. The evaporated fuel processing device of claim 10, wherein the first diffusing element and second diffusing element are each positioned such that the small-diameter opening portions thereof are not aligned with each other in an axial direction of the diffusion chamber.

12. The evaporated fuel processing device of claim 10, wherein the first diffusing element and second diffusing element include helical ribs along inner surfaces thereof.
